(19) United States
(12) Patent Application Publication
(10) Pub. No.: US 2008/0162157 A1
(43) Pub. Date: Jul. 3, 2008

(54) Method and Apparatus for creating and aggregating rankings of people, companies and products based on social network acquaintances and authoristies' opinions

(76) Inventor: Grzegorz Daniluk, Podlaska (PL)

Correspondence Address: FURR LAW FIRM, 2622 DEBOLT ROAD, UTICA, OH, 43080, US

(21) Appl. No.: 11/618,204

(22) Filed: Dec. 29, 2006

(51) Int. Cl. G06Q 99/00

(52) U.S. Cl. 705/1

(57) ABSTRACT

A method and apparatus for collecting and graduating opinions about people and products, aggregating and normalizing all opinions about a given object to one value, for searching and automatic matching potential business partners. The system consists of: social network in which users define their relationship types; reference system which graduates users' opinions basing on relationship types within the social network; innovative unilateral relationships within the social network for using experts' opinions, in which the experts' approval is not required but connection may be realized at a certain fee; application which aggregates and normalizes all information about the user or product to one value, whereas the value itself also depends on who it is presented to; application for organizing biddings, in which the system automatically presents bidding offers to users with highest opinions value and allows the both contracting parties to evaluate each other's work by submitting their public opinions.

### FIELD OF THE INVENTION

The invention here presented concerns creating and aggregating rankings of people, companies and products on the basis of public and private opinions submitted by friends and acquaintances from social network, current status of these objects, as well as using authorities' opinions about these objects.

### BACKGROUND OF THE INVENTION

Usually people make decisions about buying a given product or service basing on the opinion of their friends, reliable information from press and the Internet, advertising or the product brand itself.

Recommendations made by friends are recognized as the most influential and effective. It seems to be rather reasonable since opinions coming from friends are usually much more objective than advertising. The results of a GfK NOP survey show, however, that modern means of communication (such as e-mail) are used surprisingly rarely by people to exchange opinions about products (http://www.gfkamerica.com/news/WOMNotBlogging.htm). Moreover, the maximum number of active social connections we are able to maintain and therefore get an opinion from on a given topic is limited. According to anthropologist Robin Dunbar, this number amounts to 150 (Dunbar, R. I. M, (1992). “Neocortex size as a constraint on group size in primates”, Journal of Human Evolution, Vol. 20: 469-493). It has occasionally been called a “magic number”.

The number of products and services that we are able to buy is extremely high. Due to this fact, ironically, it is more difficult to make a decision concerning the purchase. Research shows that people are able to make their final decision about their purchase much more easily when confronted with 3-4 products rather than with for example 15. Barry Schwartz concentrates on the paradox of excessive choice in his book “The Paradox of Choice: Why More Is Less”.

All these factors contribute to the fact that people's decisions are much more difficult and less satisfactory at the same time. They are usually taken basing on the product brand or company reputation.

There is a side-effect to it as because of that companies are forced to spend a lot of money on advertising their products and services in order to make sure that customers know what is the best. This is not the most productive way of using financial resources. Most customers would prefer the money spent on advertising to be saved and used to make the products cheaper and of higher quality. This concerns first of all non-luxury products, i.e. products which are not bought with the intention of enhancing one's social status.

In case of small companies' services, i.e. services which are bought by a specific customer only once in many years, the incentive to improve the quality of services is rather low. This is caused by the fact that the opinion of one specific customer is relatively irrelevant, as the probability that the same customer will come back to buy exactly the same services is low. Moreover, the positive opinion of a given customer does not reach a big group of people. All these factors do not have positive influence on contractors' willingness to change their attitude.

The above described problems have already been approached in different ways. Traditional ways of information distribution, such as press advertisements or yellow pages, are medium-limited. They provide a one-way communication only, and thus cannot bring a solution to the above described difficulties.

It is the Internet that has enabled an easy, cheap and two-way exchange of information. eBay, an online auctions provider, created a reference system which allows you to evaluate your business partner. The system itself is simple. Upon the completion of a transaction both the buyer and the seller submit opinions about each other: positive, neutral or negative. Next all the opinions received by a given user are summed up and the result is presented in his/her public profile. A potential business partner can therefore see the number of opinions of the given user in every of the three categories. Every opinion can additionally be supplemented with a comment.

The reference system as popularized by eBay can partially help at choosing a business partner for auction transactions. It is, however, limited to the Internet auctions only. In the real word auctions are not that popular. Moreover, a high number of opinions typical for popular sellers is rather difficult to analyze; it is difficult to see which opinions are objective. Long-established eBay sellers usually have already thousands of positive and dozens of negative opinions. They try to use their position and experience. If a user has a high number of positive opinions, one negative opinion cannot change much in the percentage proportion of all their positive and negative opinions. In case of problems and a possibility of being given a negative opinion, long-established sellers try to blackmail honest users by submitting negative opinions about them. As a result some eBay users are now afraid to post a negative opinion about a seller with a high number of positive opinions. Some cases have even ended up in court because buyers wanted eBay to remove the negative opinions submitted by the seller in response to the negative opinion submitted by the buyer. eBay's policy, however, does not allow to in any way intervene in the disputes of people using their reference system. All the trouble and costs connected with legal proceedings could be so high that the whole auction system would not be profitable anymore.

In the eBay reference system all the opinions are of equal value. It does not depend on whether the user's identity has somehow been additionally verified or not. The summed up value of opinions presented to the user does not depend on who the author of the opinions is, or, more specifically, if the author of the opinions is a friend of the person checking the opinions. This poses another problem; it is difficult to trust opinions coming from strangers. Moreover, a person who only starts their activity on eBay has not collected that many positive opinions yet, and therefore his/her position is weaker in comparison to the well-established users.

As far as private life is concerned a lot has been done to help people to find their life partner. Social networks popularized by Six Degrees (U.S. Pat. No. 6,175,831) and Friendster (U.S. Pat. No. 7,069,308) use a network of private contacts to do the following: find a potential partner; collect information/opinions about a given person from people who are involved in the contact pathway between the two social network users; and to read opinions submitted by another social network user about a given person.

The functionality of current social networks, however, is limited. Friendly relationships are binary, i.e. either “I know” or “don't know” a given person. The network is mainly used to find the contact path between two people. After finding the right “path” it makes it possible to use the people from the path to introduce yourself to a given person. The main objective of these networks has been to create systems which would help to find friends or life partners. They are often referred to as “dating sites”.

The social network by Linkedin.com uses the contact network to find a potential employer or employee. It also gives you a possibility to submit an opinion about a person that you know. This solution is in general similar to social networks mentioned above, i.e. dating sites. The main difference is the objective that you have when referring to these networks.

The Internet also offers copies of the eBay reference system, e.g. http://www.ikarma.com, http://www.rapleaf.com/, which, however, do not change the opinions counting process. These reference systems are similar to the eBay's system.

Revolutionary psychologist Robert Wright, in his book “The Moral Animal” presents a hypothesis that some basic behavioral patterns are determined by genes. He also suggests that evolution has discovered game theory and people follow certain rules in their behavior. According to Robert Wright people have usually a positive attitude towards each other at the first encounter. In human history this approach would allow cooperation. This in turn would prove mutually beneficial, in fact more beneficial than if the both parties would decide to work separately. It is crucial that the both parties cooperate with each other not because of their “being basically good” but because of benefits that this approach can offer for them both. This contradicts the common belief that people are “good by nature”. Robert Wright says that this behavior is subconscious, which makes its analysis even more difficult. According to this hypothesis people follow the rules of a certain game. It is essential that the rules and conditions of this game bring optimal and long-term positive effects for the whole society. The rules of the game, however, are not constant. In the past 200 years urban centers have developed significantly; people are forced to function in dense concentrations. New conditions have changed the game rules among society members. People started to have big problems with the exchange of vital information, e.g. about good and bad contractors.

Poor exchange of reliable information among society members about products and contractors causes changes in human behavioral patterns. New behavioral patterns are being created, in which people try to take advantage of the other poorly informed party. Many people have experienced treatment like that personally. In their cooperation they have been used by the other party, whereas the other party is able to carry on their operation in society uninterruptedly due to poor exchange of opinions in largely populated areas.

Disruption in information exchange has led to changes in game rules and as a result to changes in players' behavior. From the point of view of all players, i.e. the whole society, these are not necessarily changes for good. Current technological and economic development somehow compensates for the loss, but the general opinion about omnipresent social indifference serves as a proof that something has been lost.

The eBay.com reference system has probably been based on the assumption that people are basically good. eBay founder, Pierre Omydyar mentions it in his interview at Release 1.0's PC Forum 2006 in Carlsbad, Calif., This might have influenced the construction of the eBay reference system. Yet, according to Robert Wright the assumption that people are “basically good” only partially describes the whole process of human behavior. People are usually good at their first encounter, but their further behavior depends on conditions and benefits that the both parties can gain from subsequent encounters. This is a rule which can be deliberately used by a dishonest person. Taking into account the financial success of eBay, it is quite easy to understand why the company at some point stopped working on the improvement of its reference system. The success of the eBay auction system proves that their reference system is a step forward in the right direction. It is not, however, the best or most optimal solution. eBay does not work on improving its reference system, but in 2005 it made a step in a different direction. It bought Skype, a company which created a popular computer program allowing verbal communication and video conferences via the Internet. One of the reasons behind the acquisition was to integrate this software with the eBay auction system. This was to make the communication between potential business partners easier. In my opinion, however, this was not a step in the right direction as far as raising confidence and trust between partners prior to the transaction is concerned.

Psychologist Robert B. Cialdini, in his book “Influence: Science and Practice” describes different techniques of sellers' influence on customers. The fact that the customer can directly see and speak to the seller, together with the final hand-shake at the end of the transaction, does not help the customer to negotiate a better offer.

The development of the Internet and easier access to information have led to lower prices of some goods and services. Economist Steven D. Levitt in his book “Freakonomics”, describes a well-documented case in which easy access to the information about prices of term life insurances on the Internet caused the prices to drop. The simplicity of this insurance product turned out to be the key; ordinary people could easily compare the prices on their own.

A new universal ranking system of products and companies is necessary which will differentiate the opinions of friends and authorities in given fields. It will enable to define different relationships similarly to the real world in which we trust some people more and some people less. Using computer systems and databases, this system will provide the user with an explicit normalized and aggregated value/opinion about a given product or contractor. In most cases every person must make up their mind and choose only one product or contractor for a specific task. The system should in an easy way present potential products and contractors to the user.

The primary goal of the system should be to create the conditions and game rules which will lead to maximization of the number of goods produced/achieved by cooperating system users.

### SUMMARY OF THE INVENTION

The present invention provides a system for defining different relationships with other system users; sharing opinions about various products and contractors without the need of direct contact or information exchange in person; aggregating and normalizing all the accessible information and opinions to one value providing users with a well-organized, graduated ranking list of products and contractors.

The system has a Graphical User Interface for setting up the account in the system, i.e. providing basic personal details such as name, surname, e-mail address and a chosen anonymous user's nickname. After setting up the account the user can add other users to his/her contact list, as well as send an e-mail invitation to his/her friends/acquaintances who have not opened their account in the system yet.

Every user can add friends/acquaintances to his/her contact list. This is how a social network is created in the system. Friends entered directly in the list are our first degree contacts. People from our friends' contact lists, i.e. from our first degree contacts, are our second degree contacts. First and second degree contacts constitute a group called Refer Network. It comprises people that we know either directly or indirectly and who we trust. All the other people who have their accounts in the system are recognized as users from outside of the personal Refer Network.

While adding friends/acquaintances to the list, the system offers a possibility to specify the relationship with a given person. The relationship type defines the level of trust/confidence in opinions submitted by a given person. The relations are as follows: Good Friend, Friend, Acquaintance or Unspecified. Good Friend determines the highest level of trust; opinions of this person are of equal value as our own. The value of opinions coming from people specified as Friends is for example 3 times smaller, whereas the Acquaintances' ones are for instance 5 times less valuable. The system is fully parametrizable and all values presented here can change according to users' requirements. Opinions from people marked as Unspecified are not specially awarded. They are treated in the same way as opinions of people from outside of the Refer Network. The value of the opinions of people from outside of the Refer Network is significantly lower than that of those from it. A lot of opinions of users from outside of the Refer Network is necessary to outbalance one opinion of the person from the Refer Network. The resulting from algorithm ratio of the value of an opinion from a Refer Network contact to an opinion from outside of it is not easy to describe in simple terms. Therefore the algorithm for aggregating and normalizing values of all opinions will be described below in the Detailed Description section.

You can set up an account in the system and it can be used to offer your commercial services. The system also allows to organize biddings/small tenders. This part of the system is not a novelty; this is an additional part of the application by the means of which users can draw contracts and submit opinions about each other. In future it can be supplemented with additional functions and program interfaces for other companies' applications.

Every tender can be completed or not. Every completed tender means that the user/customer is obliged to pay a fixed price and the contractor—to perform specified services for the customer. Upon the completion of their cooperation both the user/customer and contractor have to submit their opinions about each other. There are five possibilities: Excellent, Good, Neutral, Negative and Unacceptable. All of them have their numerical values ascribed to them, i.e. respectively 2, 1, 0, −1, and −2.

These are public opinions which are visible to all system users (similarly to current reference systems). But the system gives also a possibility to submit your private opinion. The private opinion is visible only to Refer Network friends/acquaintances. This means that every contractor can get two different opinions: the public one is a result of calculating the aggregated public opinions value; the private one is for the Refer Network friends/acquaintances. When the user does not post his/her private opinion, only his/her public opinion is recognized for his/her Refer Network.

The opinions presented here have numerical discrete values ascribed to them. But it is also possible for them to have real values from the range (−2; 2). It depends on the application.

The system allows its users to assess their business partners found among other users in the system. Other users, however, are not the only possible objects to be opinionated via the system. Apart from that the system is equipped with a module for defining products of common use. It allows to enter in the system information about the product type, producer, specific model/make, description, picture and its bar code. The information can be entered in the system by everybody, following the rule of information adding and editing adopted by the wiki systems (http://en.wikipedia.org/wiki/Wiki).

Basing on all the submitted opinions, the system calculates rankings of contractors in a cyclical way. Every user has his/her own unique ranking of contractors which is entirely dependent on his/her opinions and on the opinions of his/her Refer Network friends/acquaintances.

The user can use this ranking when looking for contractors. The calculated aggregated value and user's current demands are recognized and a normalized ranking value is processed. It is then presented to the user and is employed for grading all potential contractors.

Users' current demands can for example mean that the user needs the contractor to be available immediately, i.e. the user needs assistance or help via the phone as fast as possible; it is time that counts. The system stores the information concerning all the currently logged-in users available for customers. If a given contractor is not logged in at the moment, his/her ranking value is graded downwards. In other cases immediate availability is not required and the system does not take into account the contractor's current login status.

Other specific demands of the user may include the geographical distance between him/her and a given contractor. In cases like this the system allows the user to specify the maximum acceptable distance range. The system stores the information about the geographical location of contractors and requires from them to approximately define the distance by specifying the zip code of the area in which they operate. Having fixed the user and possible contractors' average longitude and latitude, the system assesses the distance between the customer and potential contractor. Next the normalized ranking values of contractors operating outside of the acceptable territory specified by the user are placed lower on the ranking scale.

Just like in other social networks adding new names to contact lists may be realized upon mutual consent. But the system also gives a possibility to create special accounts. Users who can be described as authorities or experts in given fields may mark their account as “authority account”. Other users will then be able to add to their contact lists the accounts of authorities that they trust, even if the authority does not know them. This is only a unilateral relation; the authority is not required to give his/her approval. The opinion aggregation is therefore also only one-sided. Only the authority's opinions are recognized in the user's ranking list, whereas the user's opinions do not influence the authority's ranking of contractors and products.

Every authority can be added to your list of contacts, i.e. included in your Refer Network, either for free or at a certain fee. The authority fixes a monthly payment that the user has to cover via the system for using his/her opinions. Without establishing a relation of this kind the authority's opinions are treated as equal to those of other anonymous system users'.

Because of this authorities' accounts can be used as a tool for selling the authorities' opinions which they have expressed in their review of a given product or service. Currently specialized magazines can be bought and respective web sites visited for product tests. The present invention simplifies the searching process. The user does not have to waste time on manual analysis of all the information on his/her own; the system can do it for him/her. The automatically calculated ranking value of the product or contractor might sometimes be not optimal enough. But in vast majority of cases it will still be better than an unassisted decision made entirely on the basis of advertising that the user has been exposed to.

It is important to point out that the system of authorities as suggested by the present invention can result in establishing a new occupation for people who will only deal with testing products or services of a given type in order to sell their reviews as their opinions via the system. Traditional information channels are too expensive and too complicated.

The invention simplifies the distribution process of reviews-opinions, as well as their “consumption” by customers. The objective is to encourage producers of various goods to improve the quality of their products with the money saved on advertising. Instead of mass advertising they can concentrate on targeted advertising addressed to independent authorities and experts who will run appropriate tests, express their opinion and therefore promote the best products only.

Thus the present invention allows to break the natural barrier of number 150 which limits the number of friends/acquaintances relationships or information exchange with a bigger group of people. Sharing opinions with the whole network of friends/acquaintances results in a significant increase in the number of people on whose accounts the opinion of a regular user is recognized. If we assume that we have 39 people stored in our contact list, and every person from this list has further 39 friends/acquaintances whose names are not yet present on other people's contact lists, the total number of unique first and second degree contacts in this network rises to over 1,500. This is the number of active social connections with people who will recognize our opinion as credible and reliable. Furthermore, the opinions of these 1,500 people will contribute to the final look of ranking lists of contractors of a given user. As we can see, this number is over ten times higher than Robin Dunbar's 150. The number of people stored in the Refer Network increases the power of opinions submitted by one single user. This in turn serves as a stronger stimulus for contractors to improve the quality of their services.

The invention allows the Refer Network to expand by addition of n degree contacts; in this respect the system is fully parametrizable. In case of further Refer Network expansion with third degree contacts, the number of contacts could increase to over 59,000. The value of opinions coming from third degree contacts, however, would have to be processed accordingly. It could only be slightly higher than the value of opinions of users from outside of the Refer Network.

By defining the relationship type, the invention also allows to represent the real relations between friends/acquaintances in a much more natural way. An authority, a new one-side type of relationship is introduced, never yet met in other social networks, while definitely present in real interpersonal relations. The invention implements a new type of private opinions; also non-existent in other reference systems and yet so natural for human contacts.

The invention uses computer systems and databases for improved organization and information distribution about products and services. With opinion exchange fully automatized, it helps users to skip time-consuming analysis of all accessible information. Readily available information about contractors and products results in faster selection of better offers. Without it users very often have to make up their mind basing entirely on the product, advertising, specialized press articles, contractors' condition, or information delivered by them.

The present invention is to help to restore the balance between a large number of currently available products and contractors, and easy access to reliable information about them. It improves the conditions and rules of the game between customers and contractors/producers, which in consequence will make the quality of their products and services better.

### BRIEF DESCRIPTION OF THE DRAWINGS

FIG. 1 shows a block diagram of the whole system;

FIG. 2 outlines the database;

FIG. 3 depicts a diagram which illustrates the process of closing a contract and submitting an opinion;

FIG. 4 shows a diagram of Refer Network; and

FIG. 5 shows the process of opinions aggregation.

### DETAILED DESCRIPTION

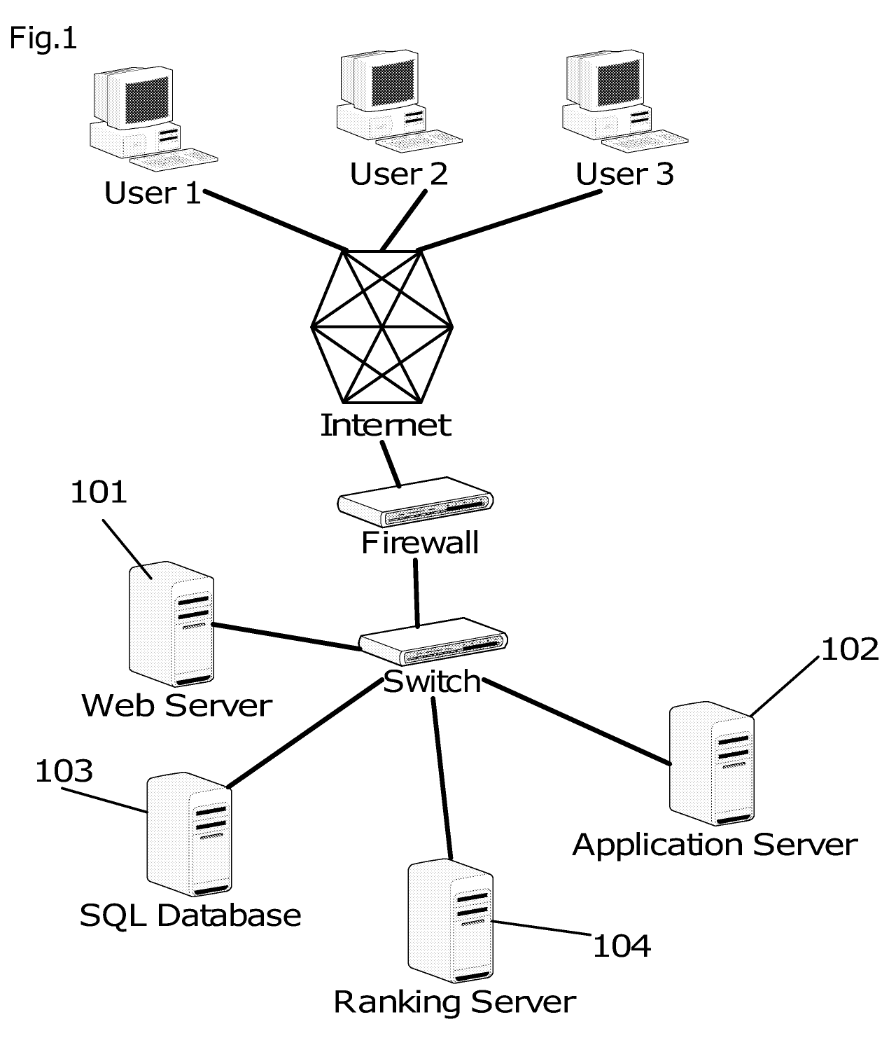

FIG. 1 (User 1, 2, 3 . . . ) presents the general structure of the system. It has been simplified, i.e. it does not show the way in which a large number of inquiries can be handled (load balancing, master/slave SQL database servers). These are standard working methods of similar systems and their detailed description is not necessary to understand the operating of the present invention.

Web server 101 deals with HTTP inquiries coming from users (e.g. User 1, 2, 3). The inquiries include requests for HTML pages, as well as for data entered in HTML forms. Web server 101 transfers these inquiries to Application Server 102. Application Server 102 handles the inquiries and sends HTML pages in response. In order to handle an inquiry the Application Server takes or stores the data in the SQL 103 base. Inquiries concerning ranking values are transferred to Ranking Server 104.

Ranking Server 104 stores the calculated Dynamic Rank lists (described below). Inquiries for this server include all the information on the basis of which Ranking Server 104 calculates, graduates and transfers the final values in response to the Application Server.

Database

The following conventions have been adopted in the construction of the database. Every table contains an artificial ID key. In the exemplary implementation of the system the Object Relational Mapper framework is employed where the ID fields are used for the object identification. Foreign keys contain the name of the table in singular, the ID suffix, and the prefix describing the function of a given table field.

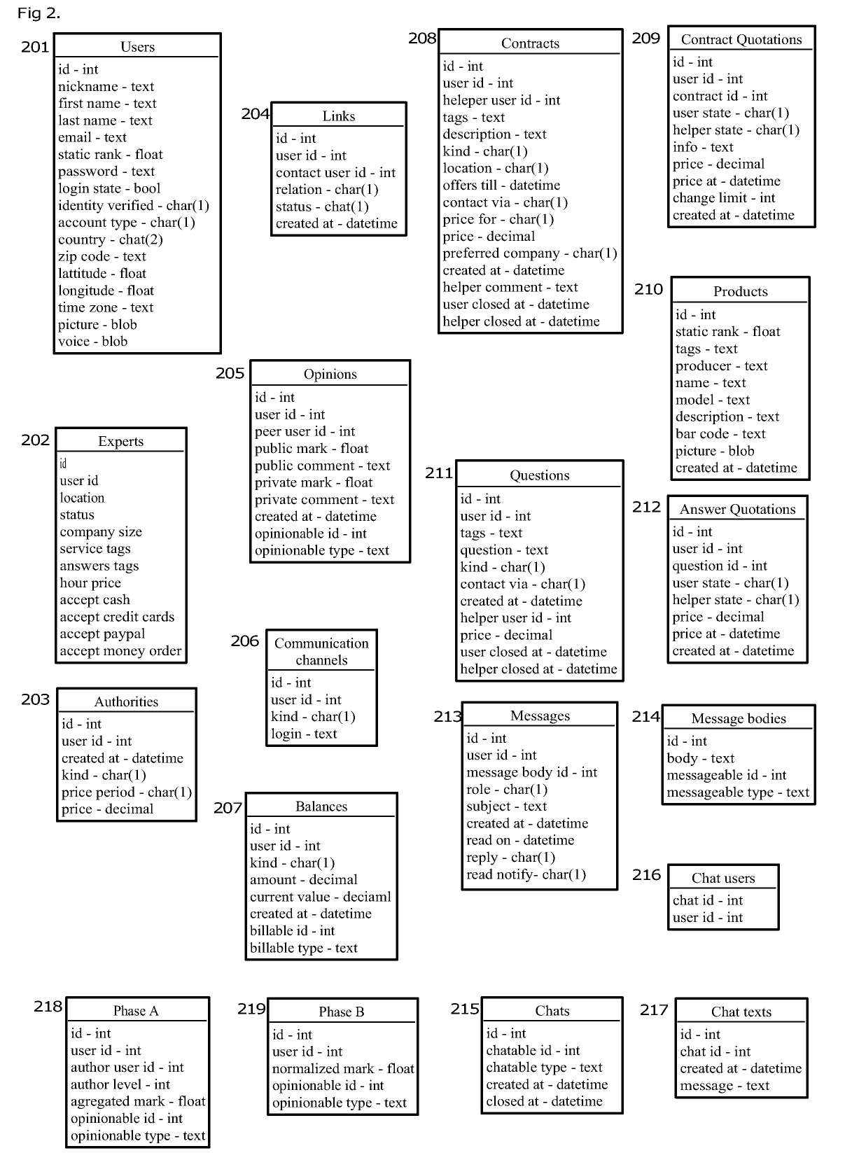

FIG. 2 presents structure of indispensable data stored in the SQL base.

Users 201: the table stores basic information about users;

Experts 202: the table stores information about users who render services; it supplements the information stored in 201—Users;

Authorities 203: the table stores information about users recognized as authorities; similarly to 202—Experts, it stores additional information about users;

Links 204: the table stores information about users' contact lists; relation refers to the relationship type existing between the user and a given contact person; status applies to the connection status, e.g. if the connection was accepted by the other person; in case of bilateral relationships (for example Good Friend or Friend) two records are stored in the base, one for every user);

Opinions 205: the table stores information about public and private opinions submitted about other system users or products;

Communication Channels 206: the table stores information about all communication programs entered and used by the user; this can include telephone numbers or logins of Instant Massenger programs;

Balances 207: the table stores information about the user's financial transactions; these can include monthly account management fees, fees for answers to paid inquiries, income from answers to inquiries, fees for using authorities' opinions; billable shows objects connected with payments;

Contracts 208: the table stores information about contracts drawn by two system users;

Contract Quotations 209: the table stores users' replies to offers of contracts;

Products 210: the table stores information about products which can be opinionated by users;

Questions 211: the table stores information about inquiries posted by users waiting for offers of paid answers;

Answer Quotations 212: the table stores users' replies to offers of paid inquiries; it also includes the price quoted for an answer;

Messages 213: the table stores information about messages exchanged by system users; a separate record is created for every user (both the author and addressee);

Message Bodies 214: the table stores contents of messages;

Chats 215: the table stores information about system users' open chats;

Chat Users 216: the table stores information about chat participants;

Chat Texts 217: the table stores messages sent by users;

Phase A 218: the table stores records of the first phase of the Dynamic Rank algorithm (described below);

Phase B 219: the table stores records of the second phase of the Dynamic Rank algorithm; Tables directly connected with the innovative part of the invention are as follows: Users 201, Authorities 203, Links 204, Opinions 205, Phase A 218, Phase B 219.

The remaining tables help at organizing biddings (Contracts 208, Contract Quotations 209, Questions 211, Answer Quotations 212, Experts 202), and communication among system users (Communication Channels 206, Messages 213, Message bodies 214, Chats 215, Chat users 216, Chat texts 217).

Definitions

User 201. A person or a company with a registered account in the system.

Identity Verified. Denotes the 0, 1 flag value. Originally the 0 value is set up for all newly registered users. Whenever a credit card payment is made by a user, the name and surname provided before are additionally verified with the card details. After the details are confirmed, the user's flag is changed to 1. In the exemplary implementation a credit card of the user is used. In future after the system becomes popular enough, digital signature can be used for verification purposes.

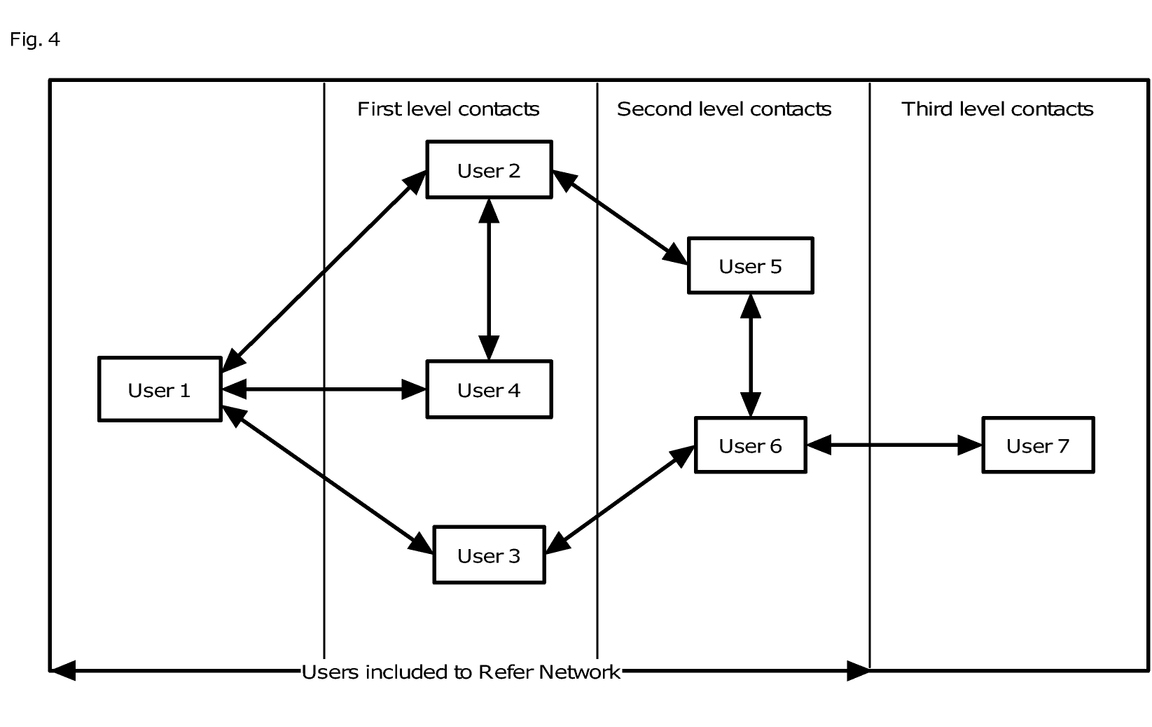

First Degree Contact. Users from contact lists, as shown in FIG. 4.

Second Degree Contact. Users from contact lists of users defined as First Degree Contacts, at the same time not being First Degree Contacts, as shown in FIG. 4.

n Degree Contact (for n>2). Users from contact lists of the n-1 degree contact, at the same time not being the 1, 2, . . . , n-1 degree contact.

Helper. A system user rendering his/her services via the system.

Authority Contact. A user from contact lists with the Authority account.

Refer Network of User A. A group of users comprising User A and his/her First and Second Degree Contacts (including Authority but excluding Unspecified contacts).

Level of Trust. The type of relation defining the level of trust for First Degree Contacts or

Authority Contacts. Current relation types include Good Friend, Friend, Acquaintance, Unspecified.

Deal. A contract closed between two system users concerning execution of a certain job at a fixed price.

Public Opinion. The evaluation submitted by both parties of every deal after it is finished or while it is still in progress. Current possible opinions are as follows: Excellent, Good, Neutral, Negative, Unacceptable.

Private Opinion. The evaluation submitted after Public Opinion has been posted; it has the same value range visible to Refer Network contacts only (excluding Authorities);

Public Comment. A text comment added to Public Opinion.

Private Comment. A text comment added to Private Opinion.

Availability Status. True/False flag showing when a user is logged in and accepts new deal offers;

Distance. A distance between two users as expressed in miles or kilometers, and calculated on the basis of geographical locations specified by users (latitude and longitude) by the means of the Great-circle distance algorithm (http://en.wikipedia.org/wiki/Great-circle_distance).

Object Rank. Normalized and aggregated real value of all opinions received by User A and presented to User B. The value depends not only on User A, but also on the relationship type between users submitting opinions about User A and User B. The process of value calculating is explained in detail below.

Web site. A computer system sending information as HTML sites, XML files to the user's computer via the Internet. The computer system consists of software and equipment.

Submitting Opinions

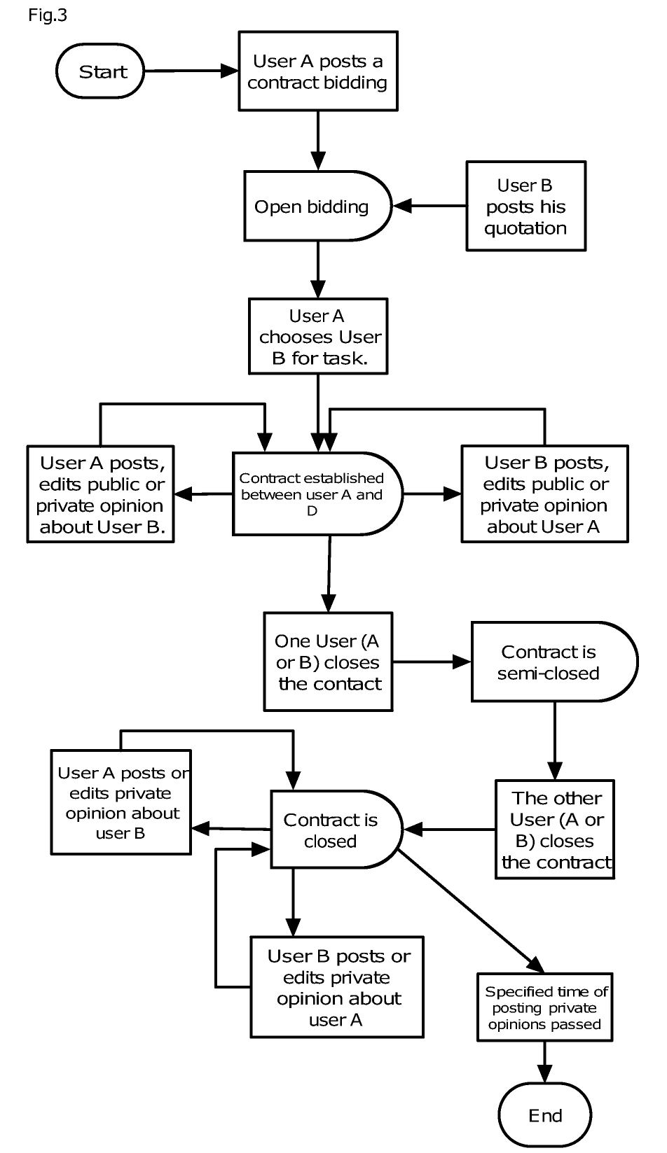

FIG. 3 depicts the way in which two users close a deal (a contract) and then submit public and private opinions about each other.

The key element of the process is mutual consent of the both parties to cooperate; after that they can evaluate each other in their public and private opinions.

Object Rank

The most innovative part of the present invention is based on its reference system which recognizes personal relationships between people submitting opinions and a person checking opinions about a given object (a contractor or product), as well as on making the public opinion value dependent on identity verification performed by the system user, and current demands of the user checking the opinions (Current Demands Factors).

Object Rank Components

Static Rank. Value ascribed to the user and used to calculate Object Rank for all users.

Dynamic Rank. Value ascribed to the object and calculated separately for every system user on the basis of all received opinions.

Current Demands Factors. User's current needs depending on the specific application, graduating the Static Rank and Dynamic Rank values.

Static Rank Calculation

Static Rank is a ranking value of a given object calculated on the basis of public opinions received by the object (e.g. the user) from other users, and additional components, such as identity verification performed by the opinion provider.

Currently the system calculates Static Rank basing on two components:

1. Identity Verified of the opinion provider.

2. The total value of all public opinions received by the user.

Pseudo-algorithm for Static Rank calculation of User 1 (U1):

```
/* op_order - the opinions order starting with the last opinion towards the
older ones; the most recent opinions are specially awarded. */
/* MaxOrder - the opinion number after which the opinion value is
graded down almost to zero; In the exemplary implementation
MaxOrder equals 100. */
/* all_op_value - aggregated value of all opinions. */
op_order := 0
all_op_value := 0
for each op in all opinions U1 got do
    /* multiply opinion value by 2 to increase value of the excellent
opinion over the good opinion */
    op_value := (op.mark * 2) * (cos(PI * op_order / MaxOrder) +
    1) / 2)
    op_order := (op_order + 1) mod MaxOrder
    if op.author Idendity not verified then
      /* decrease opinion value of unidentified user */
      op_value := op_value / 5
    end
    all_op_value := all_op_value + op_value
end
/* MaxSRank - the critical value of the aggregated sum of opinions after
which its further increase is normalized by the exp. function */
if all_op_value > 0 then
    all_op_value := 1 − exp(− all_op_value * 2 / MaxSRank)
else if all_op_value < 0 then
    all_op_value := − (1 − exp(all_op_value * 2 / MaxSRank))
end
static_rank := (U1 idendity verified * IdendityWeight / 100) +
(all_op_value * OpinionWeight / 100)
```

Following the currently accepted factors the final Static Rank value consists in 40% of Identity Verified and in 60% of normalized sum of Public Opinions.

Dynamic Rank Calculation

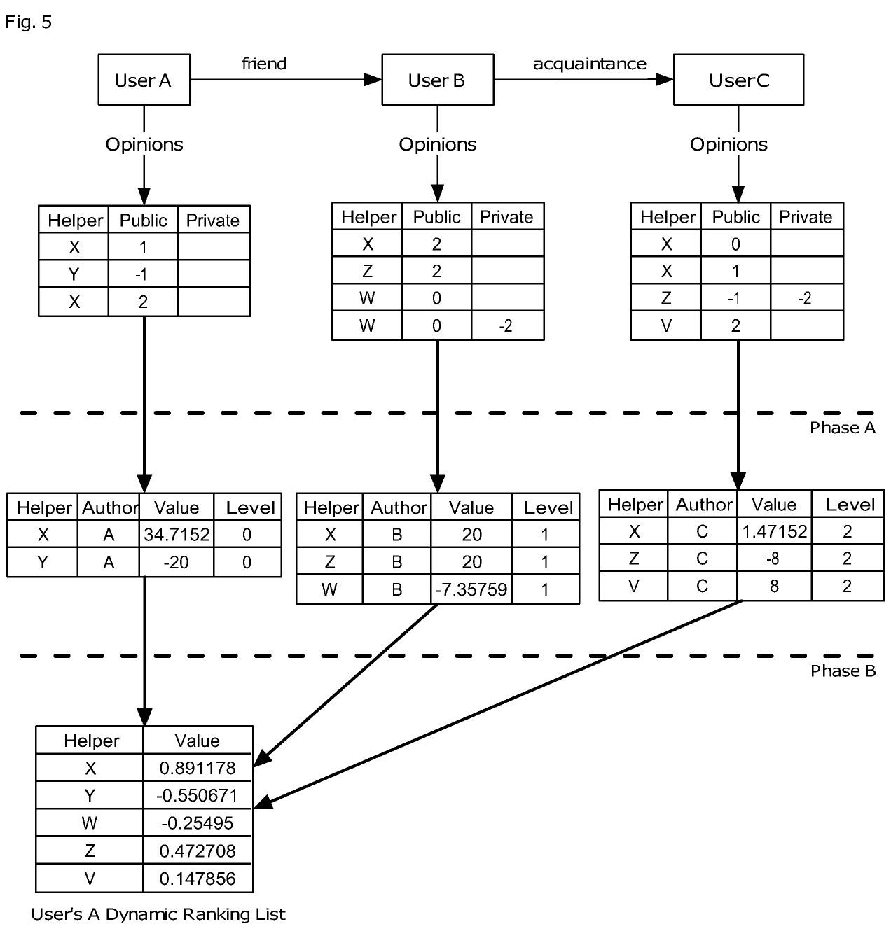

Every system user 201 has his/her own Dynamic Rank list. The ranks from this list represent the aggregated and normalized value of opinions about object such as other system users (contractors, products). The value is calculated on the basis of opinions of Refer Network friends/acquaintances and stored in the database. FIG. 5 shows the process of Dynamic Rank calculation.

Dynamic Rank calculation for User A consists of two phases: phase A and phase B.

In phase A all opinions about a given object are aggregated to one value for every user from Refer Network of User A.

In phase B, basing on the data from phase A, an aggregated and normalized opinion is calculated for every object that was given an opinion by any user from Refer Network of User A.

As a result of the both phases a list of opinionated objects is set up with one numerical value ascribed to them from the range (−1; 1).

Phase A pseudo-algorithm for Dynamic Rank calculation for User A uses Breadth-first search, a well-known graph search algorithm for User A's First and Second Degree Contacts iteration.

```
/* level - distance from dynamic list owner */
/* op_power - trust level of opinion based on opinion author relation to
the list owner */
/* RELATION_VALUES - coefficients defined for all relation types. */
u := User_A
u.level := 0
u.op_power = RELATION_VALUES[‘A’]
/* queue - queue of users to process */
/* processed - a set of processed users */
queue := [u]
processed := [u]
while not queue.empty? dp
    current_user := queue.shift
    process_user(User_A, current_user)
    /* MaxLevel - contact maximum level, set to 2 in this
    implementation */
    if current_user.level < MaxLevel
    for each link in current_user.links do
      if not processed.include?(link.contact) then
        if l.relation.in?(‘A’, ’B,’C’) then
          l.contact.level := current_user.level + 1
          l.contact.op_power :=
          RELATION_VALUES[l.contact.relation]
          processed.push (l.contact)
          queue.push (l.contact)
        end
      end
    end
end
function process_user(Owner, u)
    G := get all opinions grouped by opinionable Id
    for each group g in G do
      sort opinions in g by created_at
      /* mark - aggregated value of opinions */
      /* order - the opinions order starting with the most recent one. */
      /* MaxOrder - the number of opinions the value of which is the
most important; in the exemplary implementation MaxOrder equals 3. */
      mark := 0
      order := 0
      for each opinion o in g do
        if o has private mark
          user_mark := o.private_mark * 2 * u.op_power
        else
          user_mark := o.public_mark * 2 * u.op_power
        end
        mark := mark + (user_mark * exp( − order * 2 / MaxOpinions))
        order := order + 1
      end
      create phase1 record for Owner with data ( author := u,
            level := u.level
            opinionable Id := opinionable Id of group g
            mark := mark )
    end
end
```

Phase B pseudo algorithm for Dynamic Rank calculation for User A:

```
G := get all phase1 records grouped by Opionionable Id
for each group g in G do
    /* mark - the aggregated value of opinions. */
    /* LEVEL_FACTOR - the value of an opinion depending on
the social network position in relation to the Dynamic Rank list owner. */
    /* MaxSum - the critical value of the aggregated sum of opinions
after which its further increase is normalized by the exp. Function. */
    mark := 0
    for each record r in group g do
      mark := mark + r.mark * LEVEL_FACTOR[ r.level ]
    end
    if mark > 0 Then
      mark := 1 − exp(− mark * 2 / maxSum)
    else
      mark := − (1 − exp(mark * 2 /maxSum))
    end
    create phase2 record for User A with data (opinionable Id :=
opinionable Id of group g
                mark := mark )
end
```

Dynamic Rank lists can be calculated in a cyclical way, for example twice a day when computer systems traffic is the smallest; or whenever a new opinion is added by the user 201, the system can update all dependent Dynamic Rank lists. In the implementation described here phase A and B results are counted in a cyclical way and stored in the database. This implementation serves as an example. Another implementation can calculate the Dynamic Rank lists for the user whenever it is necessary, i.e. when such list is requested.

The above described process can result in very long Dynamic Rank lists with thousands of records. The system solves this problem in the following way: it does not store in the database the Dynamic Rank records the value of which is close to zero. Because of that objects with best and worst opinions can be recorded in the database, which will allow the user to select very good and avoid very bad objects.

For example if a Dynamic Rank list has more than 10,000 records, the system can store in the database the selected top 5,000 and bottom 5,000 Dynamic Rank records.

Current Demands Factors

Current Demands Factors constitute the last phase of Object Rank calculation.

Login Status. User A is looking for a contractor but the contact needs to be established as fast as possible. The Dynamic Rank value for contractors is graded depending on their current log-in/log-out status.

```
if User_X is not logged
    Object Rank := Dynamic Rank * 1/3
else
    Object Rank := Dynamic Rank
end
```

Common Languages. User A is looking for a contractor and requires that the contractor speaks a language that User A knows well. The value of opinions from friends/acquaintances may prove insufficient. Friend B from Refer Network of User A who submitted an opinion about Contractor C, may speak different languages than User A. If languages of Users A and C do not match, the final Object Rank value of User C—from User A's point of view—will be graded downwards.

Pseudo-algorithm for Dynamic Rank graduation in reference to common languages of Users A and C is as follows:

LANG_LEVELS_COUNT = 4

| | | |
|---|---|---|
| factoring[LANG_LEVELS_COUNT] = | [ 1, | // for Native speaker |
| | ⅘, | // for Advanced |
| | ½, | // for Intermediate |
| | ¼] | // for Beginner |

```
factor = 0
for i = 1 to Lang Count of User_A do
    for j = 0 to Lang Count of User_B do
      if User_A.langs[i] == User_B.langs[j] then
        factor := max(factor, factors[User_A.lang_levels[i]] *
          factors[User_B.lang_levels[j]])
      end
    end
end
if factor == 0 then
    factor := 1/32
end
Object Rank = Dynamic Rank * factor
```

Geographical Distance. User A is looking for a contractor but wants to meet with him/her in person. Thus geographical/physical distance can also have influence on Dynamic Rank grading. Pseudo-algorithm for Dynamic Rank graduation in reference to the distance between User A and B is as follows:

```
distance := compute geo distance in miles for
      User_A.latitude, user_A.longitude and
      User_B.latitude, User_B.longitude
maxd := allowed distance defined by User_A
if distance < maxd then
    factor := 1
else if distance > 2 * maxd then
    factor := 1/100
else
    factor = (cos((distance − maxd) * PI / maxd) + 1) / 2
end
Object Rank = Dynamic Rank * factor
```

More Current Demands Factors of this kind may be defined. It depends on the application. For example an Internet shop can integrate with the system via API program interfaces and use the Object Rank system to help its customers at choosing their products. But the shop may not have all the products readily available at the very moment. This is when availability of a given product may become an important element in Current Demands Factors.

Whenever a relatively cheap product (the price<$100) is currently unavailable in a given place, its Dynamic Rank can be multiplied by ½. Yet, if a relatively expensive product (the price>$300) is not available in a given place, its Dynamic Rank can be multiplied by ⅘. In the first case the product may be cheap, but its Dynamic Rank value is lowered more significantly in comparison to the second case. This is because in case of low price products, customers would probably not be interested in wasting their time on additional search in other places. The fact that the price is low anyway, so the investment and risk are not that high, will not encourage them to further searching. In case of more expensive products, however, customers might prefer to wait or spend more time on their research, which finds its reflection in the unavailability factor having less significant influence on the final Dynamic Rank value.

The example presented above may become especially significant once the Object Rank system gets integrated with the IT system of a traditional shop. The shop can offer special terminals to its customers, through which customers will be able to evaluate products as suggested by the Object Rank system. Interconnecting Object Rank with the current availability status of cheaper products in the shop can prove very comfortable—products one dollar cheaper, only slightly better but at the moment unavailable will not even appear on the products display.

Ranking Server

FIG. 1 depicts Ranking Server 104. This system stores information about users and their Dynamic Rank lists. The Application Server transfers here Object Rank-related inquiries.

Ranking Server operates in two phases:
1. It filtrates contractors and biddings through tags specified in the inquiry. For example, if the user is looking for Helpers specializing in Microsoft Word, the inquiry to the server should include a “microsoft word” tag. The Ranking Server will filtrate all users and in the first search phase it will display only the contractors who have the “microsoft word” tag defined in their profile. This stage is not the innovative part of the invention, so it requires no further description. This phase may be implemented in many different ways, the simplest being the use of the Full-Text Index functionality of relational databases.
2. It calculates Object Rank for the first phase search results. It displays a specific part of the whole calculated list, for example 10 records starting from position number 30. Object Rank calculation is in fact based on the previously calculated Dynamic Rank value, accordingly graduated in respect of Current Demands Factors specified in the inquiry.

Object Rank Practical Application

The rankings themselves constitute a part of the whole invention. But it is their usage that matters. Currently the invention is used for two specific applications.

Answers and Services.

The Answers application is used for asking questions and obtaining quick answers from other system users who offer their knowledge and services for a certain fee. The general outline is a little similar to discussion lists and web forums. After the user asks a question/posts an inquiry via this web application, the system finds all the Helpers who match the categories specified by the user together with the question. Then their Object Ranks are calculated with reference to Current Demands Factors such as common languages and login status. Next the inquiry is presented to 3 Helpers with highest Object Ranks. The question is either displayed on the web site or sent via email if a given Helper is currently not logged in. The user selects the Helper from all declared help offers. It is up to the user how much time he/she can spend on waiting for the offers. The user can either select the Helper as soon as he/she gets at least one help offer or wait for more offers to come. Apart from the page with Object Rank the user also has a possibility to display the Helper's profile and get familiar with public and private opinions about the Helper. Upon the question closure both the user and the Helper submit opinions about each other.

The Object Rank system saves a lot of time for both the user and Helper. The user does not need to look for Helpers on his/her own. The inquiry is automatically transferred to Helpers whose Object Rank is currently the highest. Helpers on the other hand do not need to browse all inquiries posted by users manually; thanks to the present invention users' inquiries are addressed to them directly. This way Helpers do not waste their time either on searching for matching tags.

The Services application operates in a similar way. It is used for organizing biddings/small tenders. The user specifies the bidding category, deadline, place, provides an exact description of the job, as well as determines the deadline for sending offers. After preparing a new bidding the system—similarly as it is in Answers—presents the information about the new bidding to three most highly valued Helpers. While calculating Object Rank in this case, the following Current Demands Factors are recognized: common languages, geographical distance (if so required by the user), and the size of the Helper's company.

Helpers supply their offers together with quoted prices within a specified period of time. After the deadline the user chooses the winning bidder following his/her Object Rank and quoted price. The selection of the successful bidder means that a contract is drawn between the User-Customer and Helper-Contractor. From now on the both contracting parties can evaluate each other in their public and private opinions. After the contract is finished, the parties still have two weeks to edit their private opinion about the partner.

### CONCLUSION

The present invention helps in distribution of information about contractors and products. So far in vast majority of cases information distribution has been rather one-sided: from producers and contractors to customers. What is missing is credible information, reliable feedback from regular customers and experts-authorities which could be easily made available to other customers. The above described invention can solve this problem. With high number of users, the invention can have a big influence on raising the quality of services and products.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A system for calculating and presenting opinions about people or products and comprising of: computer server; database with registered users; users' graded relationships with other users; separately recognized public and private opinions about objects; information about the user's verified identity; methods of grading the user's opinions depending on verified identity; methods of grading levels of trust and confidence in other system users; methods of establishing unilateral relations within the social network; methods of grading the user's opinions depending on the relationship between the user checking the opinion and the one submitting it; methods of aggregating and normalizing all opinions to one value; methods of graduating opinions about the user or product which recognize current demands of the user checking the opinion; methods of automatic ascribing n users with highest ranks to biddings/tenders organized by other users.

2. The method according to claim 1, further comprising of the following steps: graduating the value of opinions depending on whether the identity of the user submitting the opinion has been verified by the means of payment card transaction performed by the user within the system, confirming the user's name and surname entered in the system.

3. The method according to claim 1, further comprising of the following steps: defining the relationship type between users; setting the access control to the information about the other user in accordance with the relationship type; graduating opinions submitted by the user depending on the relationship type in order to present or sum them up for the users who constitute the other side of the relationship.

4. The method according to claim 1, further comprising of the following steps: adding authorities/experts to contact lists with experts' approval not being required; thus establishing unilateral social network relationships, in which experts' opinions can influence the aggregated opinions value in the user's ranking.

5. The method according to claim 4, further comprising of the following steps: setting the optimal expert's fee to be paid by the user as a condition for establishing the relation.

6. The method according to claim 1, further comprising of the following steps: submitting private opinions about a product or another system user visible and recognized in the rankings of social network friends/acquaintances and friends/acquaintances thereof.

7. The method according to claim 1, further comprising of the following steps: setting up a ranking list on the basis of public opinions and social network private opinions; aggregating and normalizing all opinions to one numerical value within a specified range.

8. The method according to claim 1, further comprising of the following steps: graduating the numerical opinions value about the user or product depending on the availability of the user or product; specifying user's availability basing on his/her login status; specifying the availability of the product on the basis of its current stock status in a shop.

9. The method according to claim 1, further comprising of the following steps: graduating the numerical opinions value about the user or product depending on the geographical distance between the user's location or storage place of the product and the location of the user checking the opinion, product price and languages spoken by both the user and potential contractor.

10. The method according to claim 1, further comprising of the following steps: automatic presentation of information which has been entered by the user to users with highest numerical opinions values.

11. The method according to claim 10, wherein the information presented consists of an offer for a task specified and posted by the user to be accordingly further transferred to other users.

12. The method according to claim 1, further comprising of the following steps: excluding from the ranking list the objects whose ranking value is close to zero, but leaving n opinionated objects from the top of the ranking and m objects from its end for saving storage space in the database.
